(19) United States
(12) Patent Application Publication
(10) Pub. No.: US 2026/0022786 A1
(43) Pub. Date: Jan. 22, 2026

(54) FLEXIBLE PIPE BODY AND METHOD OF MANUFACTURE

(71) Applicant: Baker Hughes Energy Technology UK Limited, Bristol (GB)

(72) Inventors: Fabio De Souza PIRES, Newcastle-Upon-Tyne Tyne and Wear (GB); Andre Leao MACEDO, Newcastle-Upon-Tyne Tyne and Wear (GB); Richard Alasdair CLEMENTS, Newcastle-Upon-Tyne Tyne and Wear (GB); Andrew Peter ROBERTS, Newcastle-Upon-Tyne Tyne and Wear (GB); Colin William RUSSELL, Newcastle-Upon-Tyne Tyne and Wear (GB); Garry Ian KENDALL, Newcastle-Upon-Tyne Tyne and Wear (GB)

(21) Appl. No.: 18/998,027

(22) PCT Filed: Jul. 31, 2023
(86) PCT No.: PCT/EP2023/025360

§ 371 Date: Jan. 23, 2025

(30) Foreign Application Priority Data
Jul. 29, 2022 (GB) 2211139.7

(51) Int. Cl. F16L 11/08

(52) U.S. Cl. CPC F16L 11/083

(57) ABSTRACT

A flexible pipe body for transporting production fluids, a flexible riser, and a method of manufacturing a flexible pipe body are disclosed. The flexible pipe body comprises: an internal pressure sheath; a helically wound armour layer radially outward of the internal pressure sheath; and a continuous metallic permeation-barrier layer disposed radially inward of the helically wound armour layer; wherein the continuous metallic permeation-barrier layer comprises a helically wound tape and a connection portion configured to join laterally adjacent tape wraps of the helically wound tape.

### TECHNICAL FIELD

The present invention relates to a flexible pipe body including a permeation-barrier layer, and a method of manufacturing said flexible pipe body. In particular, but not exclusively, the present invention relates to a flexible pipe body including a continuous metallic permeation-barrier layer formed from a helically wound tape.

### BACKGROUND

Flexible pipe is particularly useful in connecting a sub-sea location (which may be deep underwater) to a sea level location. The pipe may have an internal diameter of typically up to around 0.6 metres (e.g. diameters may range from 0.05 m up to 0.6 m). Flexible pipe is generally formed as an assembly of a flexible pipe body and one or more end fittings. The flexible pipe body is typically formed as a combination of layered materials that form a pressure-containing conduit. The pipe structure allows large deflections without causing bending stresses that impair the pipe's functionality over its lifetime. The flexible pipe body is generally built up as a combined structure including polymer, and/or metallic, and/or composite layers. For example, a flexible pipe body may include polymer and metal layers, or polymer and composite layers, or polymer, metal and composite layers.

API Recommended Practice 17B provides guidelines for the design, analysis, manufacture, testing, installation, and operation of flexible pipes and flexible pipe systems for onshore, subsea and marine applications. API Specification 17J titled “Specification for Unbonded Flexible Pipe” defines the technical requirements for safe, dimensionally and functionally interchangeable flexible pipes that are designed and manufactured to uniform standards and criteria.

Flexible pipe body typically includes a fluid-retaining layer (known as a barrier layer or liner) formed generally as a polymer sheath or pressure sheath. Such a layer operates as a primary fluid retaining layer. To prevent rupture of such a layer caused by the pressure of the transported fluid, an interlocked wire layer (known as a pressure armour layer) is often located radially outwards of the fluid-retaining layer. A typical flexible pipe body includes one or more armour layers, optionally including a pressure armour layer. The primary load on such layers is formed from radial forces. Pressure armour layers often have a specific cross-sectional profile to interlock so as to be able to maintain and absorb radial forces resulting from outer or inner pressure on the pipe. The cross-sectional profile of the wound wires which thus prevent the pipe from collapsing or bursting as a result of pressure are sometimes called pressure-resistant profiles. When armour layers are formed from helically wound wires forming hoop components, the radial forces from inner or outer pressure on the pipe cause the hoop components to expand or contract, putting respectively tensile or compressive loads on the wires.

One or more tensile armour layers may be positioned radially outward of a pressure armour layer(s). Tensile armour is used to sustain tensile loads and internal pressure. The tensile armour layer is often formed from a plurality of wires (to impart strength to the layer) that are located over an inner layer and are helically wound along the length of the pipe. The tensile armour layers are often metallic layers, formed from carbon steel, for example. The tensile armour layers may alternatively be composite tendons, of a matrix material reinforced with suitable fibres, for instance of glass, carbon, aramid, basalt, or metal.

As used herein, an armour layer refers to a tensile armour layer or a pressure armour layer.

Flexible pipe is utilised to transport production fluids, such as oil and/or gas and/or water, from one location to another. As used herein “fluid” includes both liquid and gases substances. When a production fluid is conveyed through a flexible pipe, fluids such as carbon dioxide and hydrogen sulphide gases, for example, can permeate the inner most layers of the flexible pipe body (for example the internal pressure sheath). As used herein, permeation, particularly permeation of a fluid through a layer of a flexible pipe, may include both transmission of the fluid through a body of the layer as well as leakage of the fluid through discontinuities or gaps in the layer, the particular meaning being readily apparent from the context of the accompanying description.

These fluids then accumulate in the pipe annulus. This may result in a corrosive environment, in particular when associated with water present in the annulus, for example during an annulus flooding event. The corrosive environment is known to lead to pipe failure due to stress corrosion cracking of the metallic layers used within armour layers.

Furthermore, a build-up of annulus fluids can cause over pressurization and mechanical failure of the flexible pipe.

Certain known examples of a flexible pipe body provide a tape layer radially outward of the internal sheath layer. As used herein, a tape refers to an elongate material provided in a wrapable or windable form, so as to form a layer by winding around a radially inward layer of the flexible pipe body. The tape layer is typical formed by winding a tape around the internal sheath layer so that a longitudinal edge of a first tape wrap overlaps the opposing longitudinal edge of the tape of a laterally adjacent tape wrap.

A problem of certain flexible pipe bodies is that fluid permeates therethrough to a pipe annulus. Fluid may permeate to the pipe annulus by transmission through a body of a layer. Additionally, or alternatively, fluid may permeate to the pipe annulus by leakage through discontinuities or gaps in a layer. In particular, while winding provides overlapping edges along the longitudinal edge of a tape, the reliability of the seal to prevent leaks depends upon surface to surface engagement. Repetitive flexing causes the overlapping surfaces to disengage from one another. Thus, fluid leaks due to it being forced between adjacent tape wraps by the pressure of the production fluids transported in the fluid pipe.

A further problem is that certain barrier layers place limits on the bending and loading limits of the flexible pipe body such that the flexible pipe cannot be flexed without damaging the barrier layer. In particular, the flexible pipe has a minimal bending radius limit which restricts the degree of permitted flex of the flexible pipe in use. That is, a flexible pipe has a lower limit for the curvature radius around which it may be bent or flexed. Flexing the flexible pipe more tightly than the minimum bending limit causes the overlapping surfaces to disengage from one another. Again, fluid leaks due to it being forced between adjacent tape wraps by the pressure of the production fluids transported in the fluid pipe.

It is an aim of certain examples of the present invention to solve, mitigate or obviate, at least partly, at least one of the problems and/or disadvantages associated with the prior art. Certain examples aim to provide at least one of the advantages described below.

### SUMMARY OF THE INVENTION

The invention is set out in the appended claims.

According to an aspect of the invention, there is provided a flexible pipe body for transporting production fluids, the flexible pipe body including:
an internal pressure sheath;
a helically wound armour layer radially outward of the internal pressure sheath; and
a continuous metallic permeation-barrier layer disposed radially inward of the helically wound armour layer;
wherein the continuous metallic permeation-barrier layer includes a helically wound tape and a connection portion configured to join laterally adjacent tape wraps of the helically wound tape. Suitably, the continuous metallic permeation-barrier layer is disposed between the internal pressure sheath and the helically wound armour layer.

Suitably, the continuous metallic permeation-barrier layer is disposed radially inward of the internal pressure sheath. More suitably, the flexible pipe body includes a carcass layer and the continuous metallic-permeation barrier layer is disposed radially between the carcass layer and the internal pressure sheath.

Suitably, the continuous metallic permeation-barrier layer is disposed radially between a pressure armour layer and a tensile armour layer, wherein the pressure armour layer is formed as a composite tape layer.

Suitably the connection portion is configured to join a first tape wrap of the helically wound tape to a laterally adjacent second tape wrap of the helically wound tape. The helically wound tape may be a helically wound metallic tape.

By providing a flexible pipe body with a permeation-barrier of continuous metallic construction, the internal pressure sheath is thereby surrounded by a sleeve without gaps or discontinuities, even when the flexible pipe body bends. Permeation of undesirable fluids by leakage to the pipe annulus is reduced or even prevented. Furthermore, the internal pressure sheath is thereby surrounded by a sleeve of a substantially fluid impermeable material such that transmission of fluid is substantially reduced. The resulting annulus environment may therefore be less severe, for example less corrosive, than a conventional flexible pipe, increasing pipe longevity.

Suitably, the continuous metallic permeation-barrier layer is positioned radially inward of and directly adjacent to the helically wound pressure armour layer.

Suitably, the connection portion extends around the circumference of the flexible pipe body.

Suitably, the flexible pipe body further includes at least one sacrificial layer radially adjacent the continuous metallic permeation-barrier layer. The flexible pipe body may include a sacrificial layer positioned radially inward of the continuous metallic permeation-barrier layer. Additionally, or alternatively, the flexible pipe body includes a sacrificial layer positioned radially outward of the continuous metallic permeation-barrier layer. Thus, the flexible pipe body may include two sacrificial layers each radially adjacent the continuous metallic permeation-barrier layer such that the continuous metallic permeation-barrier layer is arranged therebetween. The continuous metallic permeation-barrier layer may therefore be sandwiched between two sacrificial layers. As will be understood, one or more sacrificial layers may be provided radially adjacent to the continuous metallic permeation-barrier layer regardless of the position of the continuous metallic permeation-barrier layer relative to other layers of the flexible pipe body.

The sacrificial layer(s) advantageously reduce or prevent direct contact of the continuous metallic permeation-barrier layer with the other structural layers of the pipe, thereby helping to reduce wearing of the continuous metallic permeation-barrier layer. Furthermore, contact pressure between the sacrificial layer(s) and the pressure armour layer may further improve shielding against corrosive attack of the helically wound armour layer.

Suitably, the sacrificial layer(s) are polymeric layers. In this way, the sacrificial layer may provide an additional shielding effect between the contact surfaces of the sacrificial layer and the helically wound pressure armour layer. Fluids are particularly unable to permeate the tape of the helically wound pressure armour layer by transmission. Fluids are thereby restricted from moving towards gaps between laterally adjacent wraps of the pressure armour tape by contact between the surfaces of the sacrificial layer and the pressure armour layer.

Suitably, the sacrificial layer(s) may be provided via extrusion or alternatively via tape winding. The sacrificial layers may comprise any suitable polymer, for instance polyethylene, polypropylene, polyamide, polyester, polyurea, PEEK, PEKK, or PVDF, or any combination of suitable polymers.

Suitably, the continuous metallic permeation-barrier layer and the sacrificial layer are at least partially bonded to one another using an adhesive. Alternatively, the continuous metallic permeation-barrier layer and the sacrificial layer may be at least partially bonded to one another using a melt consolidation, or a melt bond, or through a spray application process. Each of these at least partial bonds is a bond without an adhesive.

Suitably, the connection portion includes a bond between laterally adjacent tape wraps. That is, the connection portion includes a bond between the first tape wrap of the helically wound tape and the laterally adjacent second tape wrap of the helically wound tape. More suitably, the bond between adjacent tape wrap of the helically wound tape includes a welded, brazed, soldered or adhesive bond.

Suitably, the continuous metallic permeation-barrier layer includes a region of overlap between laterally adjacent tape wraps, such that each tape wrap at least partially covers a laterally adjacent tape wrap. In this way, in a region of overlap, a first tape wrap at least partially covers a laterally adjacent second tape wrap.

Suitably, the bond follows a pitch of the helically wound tape. The helically wound tape includes two surfaces and a first longitudinal edge and a second longitudinal edge. The first and second longitudinal edges are mutually opposed edges extending along the helically wound tape. Thus, by following the pitch of the helically wound tape, the bond follows a longitudinal edge of the helically wound tape. The bond may be spaced from the longitudinal edge, for example where there is a region of overlap between laterally adjacent tape wraps.

Suitably, the helically wound tape includes a cross-sectional profile having at least one bent region or curved region. That is a cross-sectional profile extends across a tape wrap of the helically wound tape. For example, the cross-sectional profile extends, typically extends orthogonally, between opposing longitudinal edges of a tape.

More suitably, the cross-sectional profile includes an undulating region.

Suitably, the helically wound tape has a lay angle relative to the flexible pipe body axis, wherein the lay angle is in the range of from 20 to 80 degrees.

Suitably, the helically wound armour layer is a pressure armour layer or a tensile armour layer.

Suitably, the helically wound armour layer is a metal, typically carbon steel.

Suitably, the continuous metallic permeation-barrier layer includes stainless steel or an alloy including at least one of nickel, titanium, aluminium, zinc, copper, tin, or silver.

Suitably, the continuous metallic permeation-barrier layer includes one or more sub-layers. More suitably, each sub-layer may be formed from the same metal. Alternatively, each sub-layer may be formed from different metals, such as of any of the examples disclosed herein.

According to another aspect of the invention, there is provided a flexible riser including the flexible pipe body as described herein.

According a further aspect of the invention, there is provided a method of manufacturing a flexible pipe body, the method including
providing an internal pressure sheath;
providing a metallic permeation-barrier layer radially outward of the internal pressure sheath, wherein the metallic permeation-barrier layer includes helically wound tape;
joining laterally adjacent tape wraps of the helically wound tape via a connection portion using a bonding process; and
providing a helically wound armour layer radially outward of the metallic permeation-barrier layer, such that the metallic permeation-barrier is positioned between the internal pressure sheath and helically wound armour layer.

According a further aspect of the invention, there is provided a method of manufacturing a flexible pipe body, the method including
providing a carcass layer;
providing a metallic permeation-barrier layer radially outward of the carcass layer, wherein the metallic permeation-barrier layer includes helically wound tape;
joining laterally adjacent tape wraps of the helically wound tape via a connection portion using a bonding process;
providing an internal pressure sheath; and
providing a helically wound armour layer radially outward of the internal pressure sheath, such that the continuous metallic permeation-barrier is positioned radially inward of the helically wound armour layer.

Suitably, a method further includes a step providing at least one sacrificial layer radially adjacent the metallic permeation-barrier layer. More suitably, the method further includes a step of providing at least two sacrificial layers each radially adjacent the metallic permeation-barrier layer such that the metallic permeation-barrier layer is arranged therebetween.

Suitably, a method further includes a step providing at least one sacrificial layer radially adjacent the metallic permeation-barrier layer, wherein a sacrificial layer of the at least one sacrificial layer is extruded over a carcass layer.

Suitably, the step of providing a metallic permeation-barrier layer includes embedding the metallic permeation-barrier layer in a sacrificial layer. More suitably, the sacrificial layer is a radially inward layer.

Suitably, a helically wound armour layer is provided as one, or both, of a pressure armour layer and a tensile armour layer.

Suitably, a bonding process includes a welding, brazing, soldering, or adhesive bonding process. More suitably, a welding process is performed by one or more of Tungsten inert gas welding; metal inert gas welding; laser welding; induction heating; resistance welding;

friction welding; or roll bonding.

Suitably, a welding process or the brazing process of a method follows a pitch of the helically wound tape. That is, the welding process or the brazing process follows a longitudinal edge of the helically wound tape. The welding process or the brazing process may provide a join of laterally adjacent tape wraps that is spaced from the longitudinal edge. For example, the join may be provided in a region of overlap between laterally adjacent tape wraps.

Unless otherwise explicitly stated all features of the invention are considered combinable with one another.

Certain embodiments of the invention provide the advantage that a flexible pipe body with reduced permeation of undesirable fluids to the pipe annulus may be provided. Permeation by transmission may be reduced. Permeation from leakage may be reduced. The resulting annulus environment may therefore be less severe than a conventional flexible pipe, which can result in increased pipe longevity.

Certain embodiments of the invention allow for a more flexible pipe body. The minimum bending radius of the flexible pipe is reduced without impairing its barrier properties. The minimum bending radius of the flexible pipe is reduced without risk of damage to its barrier layer.

### BRIEF DESCRIPTION OF THE DRAWINGS

Embodiments of the invention are further described hereinafter with reference to the accompanying drawings, in which:

FIG. 1 illustrates a flexible pipe body;

FIG. 2 illustrates a riser system;

FIG. 3 illustrates an example pressure armour layer including wires wound at a certain lay angle;

FIG. 4 illustrates a cross-sectional view of an example layer arrangement of a flexible pipe body;

FIG. 5 illustrates a cross-sectional view of a portion of another example layer arrangement of a flexible pipe body;

FIG. 6 illustrates a cross-sectional view of a portion of a further example layer arrangement of a flexible pipe body;

FIG. 7 illustrates a cross-sectional view of another example layer arrangement of a flexible pipe body;

FIG. 8 illustrates a schematic of an example apparatus for manufacturing a flexible pipe body;

FIG. 9 illustrates a flow chart of a method of manufacturing a flexible pipe body; FIG. 10 illustrates a flow chart of another method of manufacturing a flexible pipe body; and

FIG. 11 illustrates a flow chart of a further method of manufacturing a flexible pipe body.

In the drawings like reference numerals refer to like parts.

### DETAILED DESCRIPTION

Certain terminology is used in the following description for convenience only and is not limiting. The words ‘lower’ and ‘upper’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

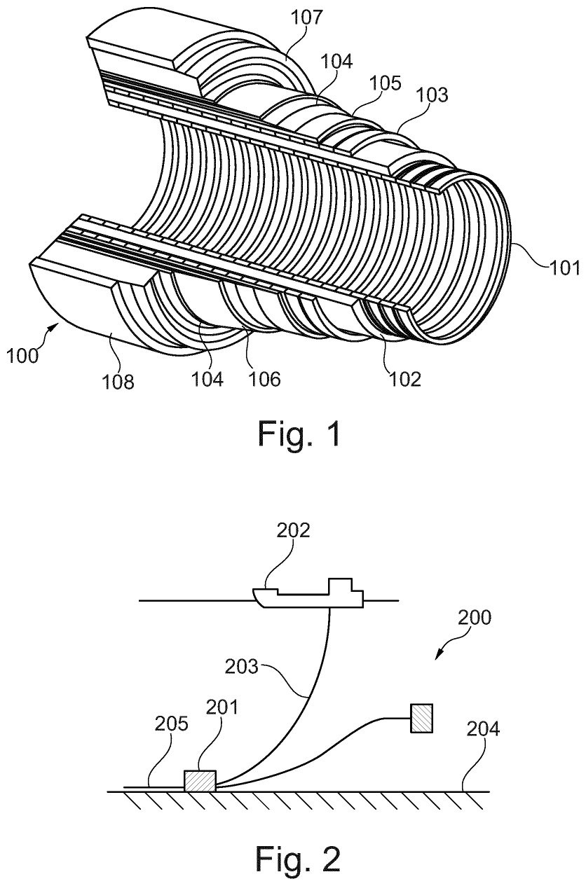

Throughout this description, reference will be made to a flexible pipe. It will be understood that a flexible pipe is an assembly of a portion of flexible pipe body and one or more end fittings in each of which a respective end of the flexible pipe body is terminated. FIG. 1 illustrates how flexible pipe body 100 is formed in accordance with an embodiment from a combination of layered materials that form a pressure-containing conduit. Although a number of particular layers are illustrated in FIG. 1, it is to be understood that the flexible pipe body is broadly applicable to coaxial structures including two or more layers manufactured from a variety of possible materials. For example, the flexible pipe body may be formed from polymer layers, metallic layers, composite layers, or a combination of different materials. It is to be further noted that the layer thicknesses are shown for illustrative purposes only.

While some layers of the flexible pipe body may be described as bonded or consolidated the flexible pipe may generally be considered an unbonded flexible pipe. That is, unless otherwise specified the various layers of the flexible pipe body are unbonded and thereby have the capacity to move longitudinally in relation to the adjacent layers during the bending or flexion of the flexible pipe body.

As used herein, layers may optionally include sub-layers. A plurality of sub-layers cooperate to form a layer with a specific purpose. For example, a sacrificial layer may be formed of one or more sub-layers.

As used herein, a composite refers to a material that is formed from two or more different materials, for example a material formed from a matrix material and reinforcement fibres. In some examples, a composite may be a composite tape layer. In other examples a composite may include an extruded layer. Fibres within a composite material may include any of carbon fibres, or glass fibres, or basalt fibres, or tensilized polymer fibres, or metal wires, or any combination thereof. It will be understood that throughout this specification, reference is made to a tape and it will be understood that this term is to be broadly construed as encompassing any elongate structure having a preformed cross section that can be wound in a helical manner around an underlying structure.

A tape refers to an elongate material provided in a wrapable or windable form, so as to form a helically wound tape by winding around a radially inward layer of the flexible pipe body. In an example, a tape is a metallic tape which is a wrapable or windable, such as the metallic material used to form a helically wound metallic tape. A tape typically includes a pair of mutually opposed longitudinal edges with a tape body therebetween.

As used herein the term lay angle refers to the angle at which a tape or layer is applied to, that is wound around, the flexible pipe body, relative to the longitudinal axis of the flexible pipe body. A tape with lay angle of 90° would be a tape wound around a radius of a cross-section of the flexible pipe body (i.e. perpendicular to the longitudinal axis of the pipe body).

It will be understood that the term radially is used to refer to a position in relation to the radius of the flexible pipe body. For example, the term radially inward is intended to refer to a position which is relatively closer to the centre, or central longitudinal axis, of the flexible pipe body and radially outward is intended to refer to a position which is relatively more distant from the centre, or central longitudinal axis, of the flexible pipe body. Referring now to FIG. 1, a traditional layer arrangement of flexible pipe body 100 is illustrated. In this example the flexible pipe body 100 includes an optional innermost carcass layer 101. The carcass layer 101 provides an interlocked construction that can be used as the innermost layer to prevent, totally or partially, collapse of an internal pressure sheath 102 due to pipe decompression, external pressure, and tensile armour pressure and mechanical crushing loads. The carcass layer 101 is often a metallic layer, formed from stainless steel, for example. The carcass layer 101 could also be formed from composite, polymer, or other material, or a combination of materials. It will be appreciated that certain embodiments are applicable to ‘smooth bore’ operations (i.e. without a carcass layer) as well as such ‘rough bore’ applications (with a carcass layer).

The internal pressure sheath 102 acts as a fluid retaining layer and includes a polymer layer that ensures internal fluid integrity. It is to be understood that this layer may itself comprise a number of sub-layers. It will be appreciated that when the optional carcass layer 101 is utilised the internal pressure sheath 102 is often referred to by those skilled in the art as a barrier layer. In operation without such a carcass (so-called smooth bore operation) the internal pressure sheath 102 may be referred to as a liner.

The flexible pipe body 100 includes armour layers, having a pressure amour layer 103 as well as first and second tensile armour layers 105, 106. As will be appreciated, the pressure armour layer 103 is optional such that, without a pressure armour layer 103, the first and second tensile armour layers 105, 106 may also substantially withstand pressure as well as tension in the flexible pipe body 100.

The optional pressure armour layer 103 is provided radially outward of the internal pressure sheath 102. The pressure armour layer 103 is a structural layer that increases the resistance of the flexible pipe to internal and external pressure and mechanical crushing loads. That is, the pressure armour layer 103 sustains radial loads. The pressure armour layer 103 provides hoop strength to the flexible pipe body 100. The pressure armour layer 103 also structurally supports the internal pressure sheath 102.

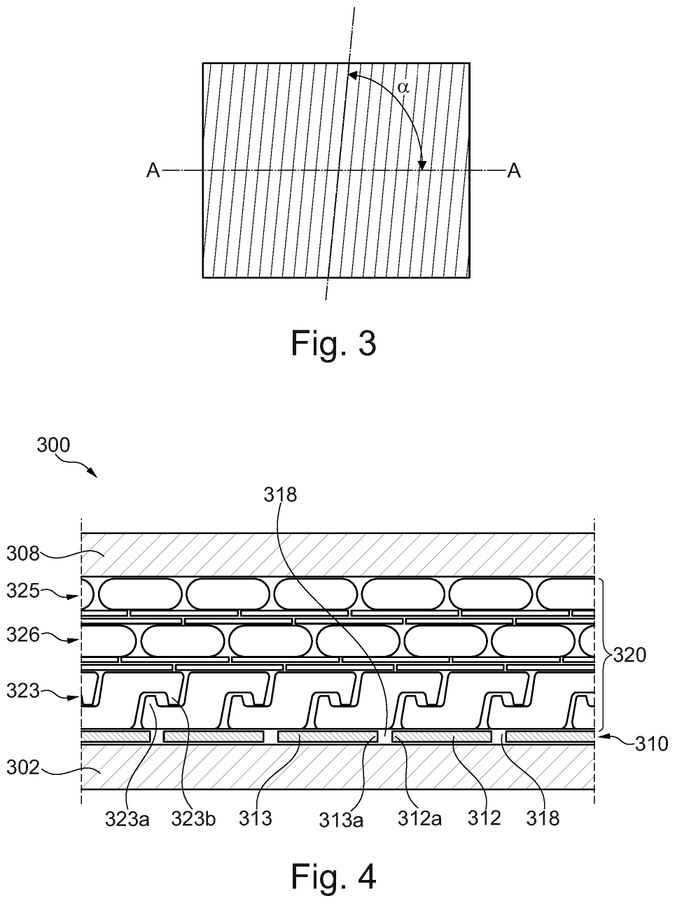

Referring additionally to FIG. 3, the pressure armour layer is formed from a helically wound arrangement of wires. The wires form an interlocked construction of wires wound with a lay angle a relative to a flexible pipe body axis A-A. The lay angle a is typically close to 90°. In this way laterally adjacent interlocking wires provide a rigid pressure armour layer 103 that provides maximal hoop strength to the entire flexible pipe body 100.

The flexible pipe body 100 also includes a first tensile armour layer 105 and a second tensile armour layer 106. Each tensile armour layer is used to sustain tensile loads and internal pressure. Further tensile armour layers may also optionally be added. A tensile armour layer is formed from a plurality of wires (to impart strength to the layer) that are located over an inner layer and are helically wound along the length of the pipe at a lay angle typically between about 10° to 55°. The tensile armour layers are often wound and counter-wound in pairs to balance torque in the pipe body. The tensile armour layers are often metallic layers, formed from carbon or alloy steel, for example, but may be higher alloy or stainless steel, or may be composite tendons.

The flexible pipe body 100 shown also includes optional tape layers 104 provided radially outward of the tensile armour layers 105, 106 which help contain underlying layers and to some extent prevent abrasion between adjacent layers.

The flexible pipe body 100 also typically includes optional layers of insulation 107 and an outer sheath 108, which includes a polymer layer used to protect the pipe against penetration of seawater and other external environments, corrosion, abrasion and mechanical damage.

Each flexible pipe includes at least one portion, sometimes referred to as a segment or section of flexible pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

Referring now to FIG. 2, there is shown a known riser assembly 200 suitable for transporting production fluid such as oil and/or gas and/or water from a sub-sea location 201 to a floating facility. For example, in FIG. 2 the sub-sea location 201 includes a sub-sea flow line. The flexible flow line 205 includes a flexible pipe 203, wholly or in part, resting on the sea floor 204 or buried below the sea floor and used in a static application. The floating facility may be provided by a platform and/or buoy or, as illustrated in FIG. 2, a ship 200. The riser assembly 200 is provided as a flexible riser, that is to say a flexible pipe 203 connecting the ship to the sea floor installation. The flexible pipe may be in segments of flexible pipe body with connecting end fittings.

It will be appreciated that there are different types of riser, as is well-known by those skilled in the art. Embodiments may be used with any type of riser, such as a freely suspended (free, catenary riser), a riser restrained to some extent (buoys, chains), totally restrained riser or enclosed in a tube (I or J tubes). FIG. 2 also illustrates how portions of flexible pipe can be utilised as a flowline 205 or jumper.

Referring now to FIG. 4 an example layer arrangement of a flexible pipe body 300 is shown in cross-section. In this example, the flexible pipe body 300 includes an internal pressure sheath 302. The internal pressure sheath 302 defines the flexible pipe bore. In some examples a carcass layer (not shown) may be provided radially inward of the internal pressure sheath 302 to define the pipe bore.

Tape layers (not numbered), and an outer sheath 308 are provided in the radially outer portion of the flexible pipe body 300. These layers are described above with reference to

FIG. 1 and so will not be described again for brevity. Although not illustrated, one or more insulating layers, as is known in the art, may also be included in the flexible pipe body 300. The flexible pipe body 300 includes an armour layer 320. In the example shown, the armour layer 320 includes a pressure armour layer formed as helically wound armour layer 323.

The armour layer 320 also includes tensile armour layers 325, 326. The tensile armour layers 325, 326 are described above with reference to FIG. 1 and so will not be described again for brevity.

The helically wound armour layer 323 includes pressure armour wires. The pressure armour wires are wrapped or wound around a continuous metallic permeation-barrier layer 310. The pressure armour wires are wound around the continuous metallic permeation-barrier layer 310 at a lay angle relative to the axis of the flexible pipe body of more than 80°.

The helically wound armour layer 323 is provided radially outward of the internal pressure sheath 302. In this example shown, the helically wound armour layer 323 is provided radially outward of the continuous metallic permeation-barrier layer 310.

The helically wound armour layer 323 has an interlocked construction. Each pressure armour wire includes opposing longitudinal edges 323a, 323b having mutually engaging features, as is known in the art. With the helically wound armour layer wound onto the flexible pipe body 300 laterally adjacent wire wraps of the helically wound armour layer 323 interlock in the region of overlapping longitudinal edges 323a, 323b. In this way, the helically wound armour layer 323 predominantly provides the hoop strength for the flexible pipe body 300.

The flexible pipe body 300 includes a continuous metallic permeation-barrier layer 310 positioned radially inward of the helically wound armour layer 323. In the example shown, the continuous metallic permeation-barrier layer 310 is provided between the internal pressure sheath 302 and the pressure armour layer 323. The internal pressure sheath 302 is positioned radially inwards of the continuous metallic permeation-barrier layer 310. In the example shown, the internal pressure sheath 302 is positioned directly radially adjacent to the continuous metallic permeation-barrier layer 310.

The continuous metallic permeation-barrier layer 310 includes a helically wound tape 312, 313. The helically wound tape 312, 313 is a helically wound metallic tape. The helically wound tape 312, 313 is wrapped or wound around the internal pressure sheath 302 to form the metallic permeation-barrier layer. Successive tape wraps of the helically wound tape 312, 313 are wound around the internal pressure sheath 302 to provide a series laterally adjacent tape wraps.

The helically wound tape 312, 313 includes two surfaces and a first longitudinal edge and a second longitudinal edge. The first and second longitudinal edges are mutually opposed edges extending along the helically wound tape 312. Thus, with the helically wound tape 312 wound around the internal pressure sheath 302 a first longitudinal edge 312a of a first tape wrap 312 abuts a second longitudinal edge 313a of laterally adjacent second tape wrap 313.

The continuous metallic permeation-barrier layer 310 includes a connection portion 318 configured to join laterally adjacent tape wraps of the helically wound tape 312. The connection portion 318 forms a bond between laterally adjacent tape wraps. In the example show, the connection portion 318 is a weld bond. Advantageously, the bond ensures that the metallic permeation-barrier layer is a continuous metallic permeation-barrier layer 310 thereby providing a continuous permeation-barrier along the flexible pipe body 300 (i.e. with no gaps, even when the pipe bends). Permeation of the undesirable fluids from the production fluids to the pipe annulus through leakage is thereby prevented. In particular, the barrier is a continuous barrier of metal. Permeation of the undesirable fluids from the production fluids to the pipe annulus through transmission is thereby prevented.

The connection portion 318 forms a weld bond between the abutting first longitudinal edge 312a of the first tape wrap 312 and the second longitudinal edge 313a of the second tape wrap 313. The connection portion 318 extends around the circumference of the flexible pipe body. The connection portion 318 coextends between first and second opposing longitudinal edges of adjacent tape wraps of the helically wound tape 312, 313 on the flexible pipe body. In this way, the connection portion 318 forms a bond following the pitch of the helically wound tape 312, 313.

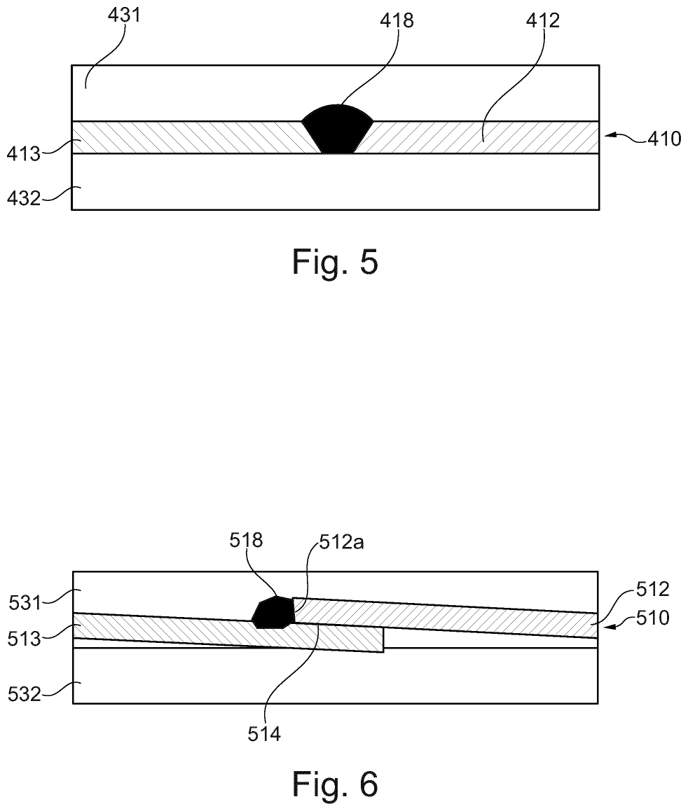

Referring now to FIG. 5, there is shown a portion of another example layer arrangement of a flexible pipe body. The flexible pipe body is substantially the same as the example described with reference to FIG. 4 other than to include two sacrificial layers. Each sacrificial layer is radially adjacent the continuous metallic permeation-barrier layer 410 such that the continuous metallic permeation-barrier layer 410 is arranged therebetween.

The use of a sacrificial layer such as the first or second sacrificial layer prevents local strain and wear.

The continuous metallic permeation-barrier layer 410 includes a helically wound tape 412, 413. The helically wound tape 412, 413 is a helically wound metallic tape. The helically wound tape 412, 413 is wrapped or wound around the internal pressure sheath 402 to form the metallic permeation-barrier layer. Successive tape wraps of the helically wound tape 412, 413 are wound around the internal pressure sheath 402 to provide a series laterally adjacent tape wraps.

The continuous metallic permeation-barrier layer 410 includes a connection portion 418 configured to join laterally adjacent tape wraps of the helically wound tape 412. The connection portion 418 forms a bond between laterally adjacent tape wraps.

Tape layers, tensile armour layers and an outer sheath are also provided. These layers are substantially as described herein with reference to FIG. 4 and so will not be described again for brevity.

In the example shown, a first sacrificial layer 431 is radially inward of the continuous metallic permeation-barrier layer 410 and a second sacrificial layer 432 is radially outward of the continuous metallic permeation-barrier layer 410. The first sacrificial layer 431 is thereby located between the helically wound armour layer (not shown) and the continuous metallic permeation-barrier layer 410. This therefore prevents direct contact of the continuous metallic permeation-barrier layer 410 and the helically wound armour layer.

The first sacrificial layer 431 will protect the continuous metallic permeation-barrier layer 410 and the connection portion 418 from damage that caused by the helically wound armour layer should they come into contact. The use of the first sacrificial layer 431 also prevents the continuous metallic permeation-barrier layer 410 and the connection portion 418 from being affected by the gaps between wires of the helically wound armour layer.

The second sacrificial layer 432 is located between the continuous metallic permeation-barrier layer 410 and the internal pressure sheath (not shown). This therefore prevents direct contact of the continuous metallic permeation-barrier layer 410 and the connection portion 418 and the internal pressure sheath. The second sacrificial layer 432 will protect the internal pressure sheath from damage during use that may be caused by the continuous metallic permeation-barrier layer 410 and the connection portion 418 should they come into contact. The second sacrificial layer 432 also partially protects the internal pressure sheath from heat which may be required to provide the connecting portion 418 in the continuous metallic permeation-barrier layer 410.

Optionally, one or both of the sacrificial layers may be bonded to the continuous metallic permeation-barrier layer 410. In the example shown, the continuous metallic permeation-barrier layer 410 and first sacrificial layer, and the continuous metallic permeation-barrier layer 410 and second sacrificial layer, are at least partially bonded to one another using an adhesive. Alternatively, the continuous metallic permeation-barrier layer and each respective sacrificial layer may be at least partially bonded to one another using a melt consolidation, or a melt bond, without adhesive. Alternatively, the sacrificial layers may be applied by spray coating processes.

Referring now to FIG. 6, there is shown a portion of a further example layer arrangement of a flexible pipe body. The flexible pipe body is substantially the same as the example described with reference to FIG. 5 other than the continuous metallic permeation-barrier layer 510 includes a region of overlap between laterally adjacent tape wraps. The continuous metallic permeation-barrier layer 510 includes a region of overlap between laterally adjacent metallic tape wraps. In this way, a first tape wrap 512, particularly a longitudinal edge 512a of the first tape wrap 512, overlaps a laterally adjacent second tape wrap 513. The second tape wrap 513, particularly a longitudinal edge (not shown) of the second tape wrap 513 subsequently overlaps a laterally adjacent third tape wrap (not shown). In this way, each tape wrap at least partially covers a laterally adjacent tape wrap.

The continuous metallic permeation-barrier layer 510 includes a connection portion 518 configured to join laterally adjacent tape wraps of the helically wound tape. The connection portion 518 forms a bond between laterally adjacent tape wraps. In the example shown, the bond is a weld bond.

The connection portion 518 forms a weld bond between the longitudinal edge 512a of the first tape wrap 512 and a surface portion 514 of the second tape wrap 513. In the example shown, the surface portion 514 of the second tape wrap 513 is an outer surface portion of the second tape wrap 513.

Alternatively, the continuous metallic permeation-barrier layer may be configured to invert the region of overlap between laterally adjacent tape wraps. In this way, the connection portion may form a bond between a longitudinal edge of the first tape wrap and an inner surface portion of the second tape wrap. Further alternatively (not shown) a connection portion may be provided between respective surface portions of both tape wraps and instead of at a longitudinal edge.

Advantageously, the bond ensures the metallic permeation-barrier layer is a continuous metallic permeation-barrier layer 510 thereby providing a continuous permeation-barrier along the flexible pipe body. The internal pressure sheath is thereby surrounded by a sleeve without gaps or discontinuities. Permeation of the undesirable fluids from the production fluids to the pipe annulus through leakage is thereby prevented. In particular, the barrier is a continuous barrier of metal. The sheath is thereby surrounded by a sleeve of substantially fluid impermeable material. Permeation of the undesirable fluids from the production fluids to the pipe annulus through transmission is thereby prevented.

The connection portion 518 extends around the circumference of the flexible pipe body. The connection portion 518 coextends with the longitudinal edge 512a of the helically wound tape 512 on the flexible pipe body. In this way, the connection portion 518 forms a bond following the pitch of the helically wound tape 512, 513.

The connection portion 518 coextends with the region of overlap between adjacent tape wraps of the helically wound tape 512, 513. In this way, the connection portion 518 forms a bond following the pitch of the helically wound tape 512, 513.

Advantageously, a weld bond between regions of overlap provides an increased bonding area between laterally adjacent tape wraps. A more reliable continuous metallic permeation-barrier layer 510 is thereby provided.

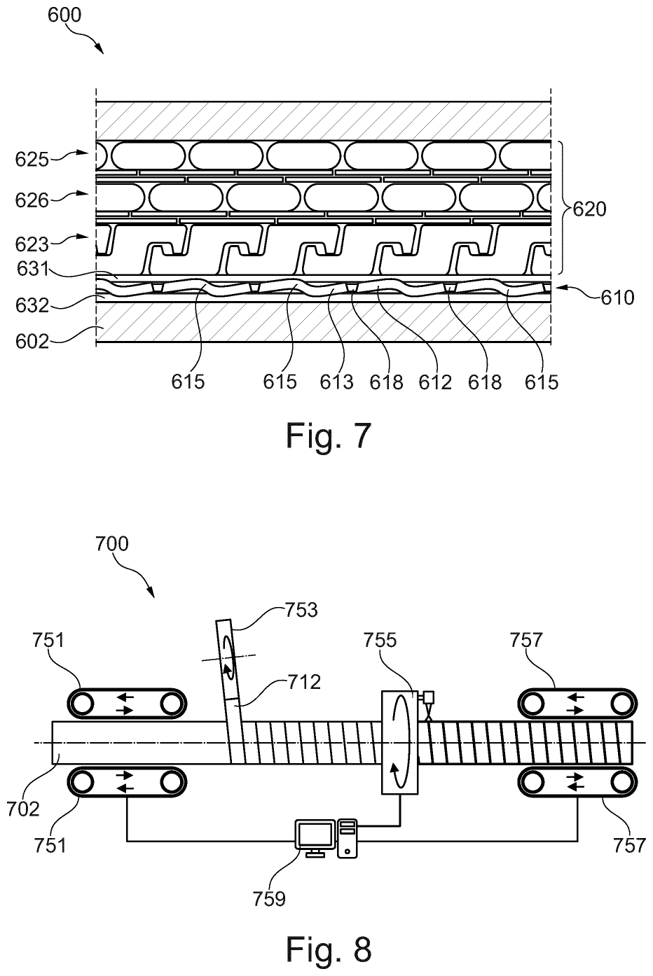

Referring now to FIG. 7, there is shown a further example layer arrangement of a flexible pipe body 600. The flexible pipe body 600 is substantially the same as the example described with reference to FIG. 5 other than the helically wound tape 612, 613 includes a cross-sectional profile including an undulating region 615.

The cross-sectional profile extends in a longitudinal direction along the tape of the helically wound tape 612, 613. Accordingly, the undulating region 615 of the cross-sectional profile extends around each tape wrap. In this way, the continuous metallic permeation-barrier layer 610 of the flexible body is generally undulating. The helically wound tape 612, 613, and thus the continuous metallic permeation-barrier layer 610, is thereby able to withstand additional axial strain. The minimum bending radius of the flexible pipe is reduced without risk of damage to its barrier layer.

As will appreciated, the cross-sectional profile may be provided in any suitable shape so that the continuous metallic permeation-barrier layer 610 withstands additional axial strain. The cross-sectional profile may include one or more bent region or curved region. For example, the cross-sectional profile may include one or more of a projection, a groove, a recess, or a concave or convex curve with respect to the internal pressure sheath. The cross-sectional profile may thereby provide one or more rib, groove or channel extending in the longitudinal direction of the helically wound tape. The cross-sectional profile may thereby provide one or more rib, groove or channel around each tape wrap.

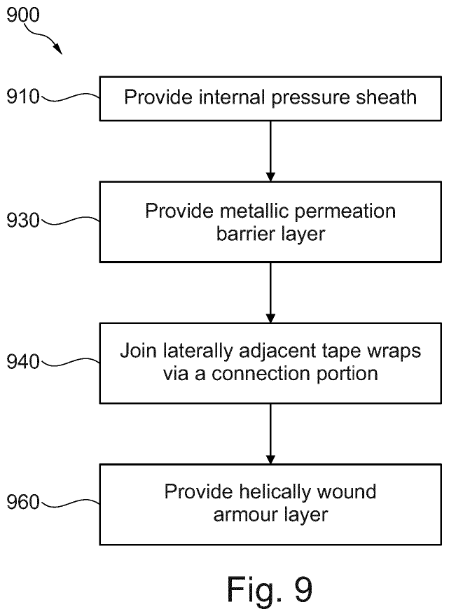

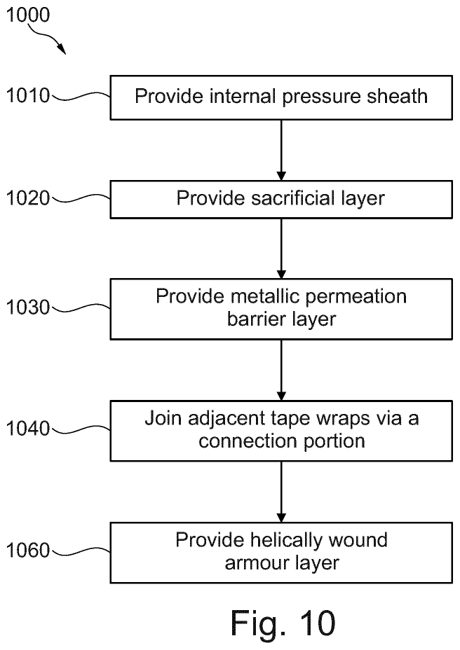

Referring now to FIG. 9, there is shown a flow chart of a method 900 of manufacturing a flexible pipe body, such as those described herein. The method may be carried out using any suitable choice of operation such as mechanically or manually winding the layers.

A first step 910 includes providing an internal pressure sheath for the flexible pipe body. Suitably, the internal pressure sheath is formed by an extrusion process as is known in the art.

A second step 930 includes providing a metallic permeation-barrier layer. The method provides a metallic permeation-barrier layer, formed from a helically wound tape, provided radially outward of the internal pressure sheath. The helically wound tape is wrapped or wound around the internal pressure sheath to form the metallic permeation-barrier layer. Successive tape wraps of the helically wound tape are wound around the internal pressure sheath to provide a series of laterally adjacent tape wraps.

A third step 940 includes joining laterally adjacent tape wraps of the helically wound tape via a connection portion. The laterally adjacent tape wraps are joined using a bonding process so that the connection portion forms a portion of the continuous metallic permeation-barrier layer. The connection portion forms a bond between laterally adjacent tape wraps. In an example method, the join is a weld bond.

Advantageously, the bonding process ensures that the metallic permeation-barrier layer is a continuous metallic permeation-barrier layer thereby providing a continuous permeation-barrier along the flexible pipe body. In particular, the barrier is a continuous barrier of metal. Permeation of the undesirable fluids from the production fluids to the pipe annulus is thereby prevented.

In an example, the method uses a bonding process to join a first longitudinal edge of a first tape wrap a second longitudinal edge of a second tape wrap. The bonding process thereby provides a connection portion which extends around the circumference of the flexible pipe body. The bonding process thereby provides a connection portion that coextends between first and second opposing longitudinal edges of adjacent tape wraps of the helically wound tape on the flexible pipe body. In this way, the bonding process, for example a welding process, follows the pitch of the helically wound tape.

A fourth step 960 includes providing a helically wound armour layer. The helically wound armour layer is provided radially outward of the continuous metallic permeation-barrier layer such that the continuous metallic permeation-barrier layer is positioned between the internal pressure sheath and the helically wound armour layer.

Referring now to FIG. 8, there is shown a schematic of an example apparatus 700 for manufacturing a flexible pipe body as described herein. Thus, an internal pressure sheath, particularly a preformed internal pressure sheath 702, is advanced to a tape laying region of the apparatus by a first actuating system 751.

Tape 712 suitable for forming a permeation-barrier layer is provided from a tape dispenser 753. The tape 712 is wound around the internal pressure sheath 702 at a lay angle relative to axis of the internal pressure sheath 702. The tape dispenser 753 is oriented so that the tape 712 is typically wound with a lay angle of from 20° to 80°. As will be appreciated, the axis of the internal pressure sheath 702 will extend coaxially with the axis of the flexible pipe body when the flexible pipe body is fully formed. In this way, any reference herein to the axis of the internal pressure sheath 702 corresponds equally to the axis of the flexible pipe body.

The internal pressure sheath 702 including the helically wound tape is advanced to a welder. In the example shown, the welder is an orbital welder 755. The orbital welder 755 joins laterally adjacent tape wraps of the helically wound tape by rotating as the tape-wrapped internal pressure sheath is advanced in an axial direction.

The orbital welder 755 joins a first longitudinal edge of a leading tape wrap to a second longitudinal edge of a following tape wrap. The orbital welder 755 provides a continuous join between a leading tape wrap and a following tape wrap of the helically wound tape. The continuous join thereby provided follows the pitch of the helically wound tape.

Advantageously, the bonding process ensures that the metallic permeation-barrier layer is a continuous metallic permeation-barrier layer thereby providing a continuous permeation-barrier along the flexible pipe body. The internal pressure sheath is thereby surrounded by a sleeve without gaps or discontinuities. Permeation of the undesirable fluids from the production fluids to the pipe annulus through leakage is thereby prevented. In particular, the barrier is a continuous barrier of metal. The sheath is thereby surrounded by a sleeve of substantially fluid impermeable material. Permeation of the undesirable fluids from the production fluids to the pipe annulus is through transmission thereby prevented.

The continuous metallic permeation-barrier layer is advanced away from the tape laying region of the apparatus by tensioners 757. The speed of advancement provided by the tensioners 757, as well as the rotation and welding speed of the orbital welder 755 are controlled by a suitable controller system 759. In this way, the apparatus 700 ensures an optimal join is provided between tape wraps of the helically wound tape.

As will be appreciated, the example apparatus 700 optionally may be modified so as to be operable with an internal pressure sheath including a sacrificial layer provided thereon. Alternatively, it will also be appreciated that the example apparatus may optionally be modified so as to be operable with an internal carcass and a sacrificial layer provided thereon. Tape suitable for forming a permeation-barrier layer is thereby wound around the sacrificial layer at a suitable lay angle and then welded in a corresponding manner.

The continuous metallic permeation-barrier layer can then be further processed to provide the additional layers of the flexible pipe body, including a helically wound armour layer, as is known in the art.

Referring now to FIG. 10, there is shown a flow chart illustrating another method 1000 of manufacturing a flexible pipe body, such as those described herein. The method 1000 is substantially the same as the method 900 described with reference to FIG. 9 other than an including an additional step of providing a sacrificial layer. The method may be carried out using any suitable choice of operation such as mechanically or manually winding the layers.

A first step 1010 includes providing an internal pressure sheath for the flexible pipe body. Suitably, the internal pressure sheath is formed by an extrusion process as is known in the art.

A second step 1020 includes providing a sacrificial layer radially adjacent to the continuous metallic permeation-barrier layer. The sacrificial layer prevents direct contact between the continuous metallic permeation-barrier layer and the internal pressure sheath. Damage that caused by such contact is prevented. The sacrificial layer additionally has some shielding properties which further reduce permeation through the flexible pipe body.

A third step 1030 includes providing a metallic permeation-barrier layer. The method provides a metallic permeation-barrier layer, formed from a helically wound tape, provided radially outward of the internal pressure sheath. The helically wound tape is wrapped or wound around the internal pressure sheath to form the metallic permeation-barrier layer. Successive tape wraps of the helically wound tape are wound around the internal pressure sheath to provide a series of laterally adjacent tape wraps.

A fourth step 1040 includes joining laterally adjacent tape wraps of the helically wound tape via a connection portion. The laterally adjacent tape wraps are joined using a bonding process so that the connection portion forms part of the continuous metallic permeation-barrier layer. The connection portion forms a bond between laterally adjacent tape wraps. In an example method, the join is a weld bond.

Advantageously, the bonding process ensures that the metallic permeation-barrier layer is a continuous metallic permeation-barrier layer thereby providing a continuous permeation-barrier along the flexible pipe body. The internal pressure sheath is thereby surrounded by a sleeve without gaps or discontinuities. Permeation of the undesirable fluids from the production fluids to the pipe annulus through leakage is thereby prevented. In particular, the barrier is a continuous barrier of metal. The sheath is thereby surrounded by a sleeve of substantially fluid impermeable material. Permeation of the undesirable fluids from the production fluids to the pipe annulus through transmission is thereby prevented.

In an example, the method uses a bonding process to join a first longitudinal edge of a first tape wrap a second longitudinal edge of a second tape wrap. The bonding process thereby provides a connection portion thereby extends around the circumference of the flexible pipe body. The bonding process thereby provides a connection portion that coextends between opposing edges of the helically wound tape of the continuous metallic permeation-barrier layer. In this way, the bonding process, in this case a welding process follows the pitch of the helically wound tape.

A fifth step 1060 includes providing a helically wound armour layer. The helically wound armour layer is provided radially outward of the continuous metallic permeation-barrier layer such that the continuous metallic permeation-barrier layer is positioned between the internal pressure sheath and the helically wound armour layer.

It will be understood that the sequence of the above steps described with reference to FIG. 10 may vary so as to provide alternative radial arrangements of the flexible pipe layers. For instance, a first step provides a sacrificial layer, then a second step provides the metallic permeation barrier layer. A third step subsequently joins adjacent tape wraps. A fourth step then provides an internal pressure sheath, followed subsequently by a fifth step to provide a helically wound armour layer. Through this sequence the continuous metallic permeation barrier layer is provided radially inward of both the internal pressure sheath and the helically wound armour layer.

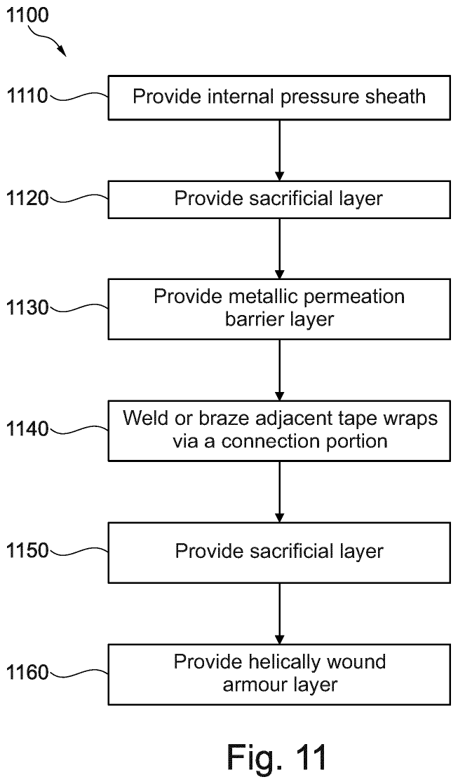

Referring now to FIG. 11, there is shown a flow chart illustrating another method 1100 of manufacturing a flexible pipe body, such as those described herein. The method 1100 is substantially the same as the method described with reference to FIG. 10 other than including a step of providing a second sacrificial layer. The method may be carried out using any suitable choice of operation such as mechanically or manually winding the layers.

A first step 1110 includes providing an internal pressure sheath for the flexible pipe body. Suitably, the internal pressure sheath is formed by an extrusion process as is known in the art.

A second step 1120 includes providing a first sacrificial layer radially adjacent to the continuous metallic permeation-barrier layer. The first sacrificial layer prevents direct contact between the continuous metallic permeation-barrier layer and the internal pressure sheath. Damage that caused by such contact is prevented. The first sacrificial layer additionally has some shielding properties which further reduce permeation through the flexible pipe body.

A third step 1130 includes providing a metallic permeation-barrier layer. The method provides a metallic permeation-barrier layer, formed from a helically wound tape, provided radially outward of the internal pressure sheath. The helically wound tape is wrapped or wound around the internal pressure sheath to form the metallic permeation-barrier layer. Successive tape wraps of the helically wound tape are wound around the internal pressure sheath to provide a series of laterally adjacent tape wraps.

A fourth step 1140 includes joining laterally adjacent tape wraps of the helically wound tape via a bond of laterally adjacent tape windings via a connection portion. The laterally adjacent tape wraps are joined using a bonding process so that the connection portion forms part of the continuous metallic permeation-barrier layer. The connection portion forms a bond between laterally adjacent tape wraps. In an example method, the join is a weld bond or a brazing bond.

Advantageously, the bonding process ensures that the metallic permeation-barrier layer is a continuous metallic permeation-barrier layer thereby providing a continuous permeation- barrier along the flexible pipe body. The internal pressure sheath is thereby surrounded by a sleeve without gaps or discontinuities. Permeation of the undesirable fluids from the production fluids to the pipe annulus through leakage is thereby prevented. In particular, the barrier is a continuous barrier of metal. The sheath is thereby surrounded by a sleeve of substantially fluid impermeable material. Permeation of the undesirable fluids from the production fluids to the pipe annulus through transmission is thereby prevented.

In an example, the method uses a bonding process to join a first longitudinal edge of a first tape wrap a second longitudinal edge of a second tape wrap. The bonding process thereby provides a connection portion thereby extends around the circumference of the flexible pipe body. The bonding process thereby provides a connection portion that coextends between opposing edges of the helically wound tape of the continuous metallic permeation-barrier layer. In this way, the bonding process, in this case a welding process follows the pitch of the helically wound tape.

A fifth step 1150 includes providing a second sacrificial layer radially adjacent to the continuous metallic permeation-barrier layer. The second sacrificial layer prevents direct contact between the continuous metallic permeation-barrier layer and the helically wound armour layer. Damage that caused by such contact is prevented. The second sacrificial layer additionally has some shielding properties which further reduce permeation through the flexible pipe body.

A sixth step 1160 includes providing a helically wound armour layer. The helically wound armour layer is provided radially outward of the continuous metallic permeation-barrier layer such that the continuous metallic permeation-barrier layer is positioned between the internal pressure sheath and the helically wound armour layer.

It will be understood that, as with the sequence of FIG. 10, the sequence steps of FIG. 11 may vary so as to provide alternative radial arrangements of the flexible pipe layers. For instance, a first step provides a sacrificial layer, then a second step provides a metallic permeation barrier layer. A third step subsequently joins adjacent tape wraps. A fourth step then provides a second sacrificial layer in step 1150. A fifth step then provides an internal pressure sheath, followed subsequently by a sixth step to provide a helically wound armour layer. Through this sequence the continuous metallic permeation barrier layer is provided radially inward of both the internal pressure sheath and the helically wound armour layer. Various modifications to the detailed arrangements and methods as described above are possible.

For example, any of the methods could be used to manufacture a flexible pipe body with the layer arrangements described herein. Thus, a method could be configured to use a continuous metallic permeation-barrier layer including a curved, bent or undulating cross-sectional profile provided on each tape wrap so as to manufacture a flexible pipe body which withstands additional axial strain.

It will be clear to a person skilled in the art that features described in relation to any of the embodiments described above can be applicable interchangeably between the different embodiments. The embodiments described above are examples to illustrate various features of the invention.

Throughout the description and claims of this specification, the words “comprise” and “contain” and variations of them mean “including but not limited to”, and they are not intended to (and do not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise. It will be also be appreciated that, throughout this specification, language in the general form of “X for Y” (where Y is some action, activity or step and X is some means for carrying out that action, activity or step) encompasses means X adapted or arranged specifically, but not exclusively, to do Y.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body for transporting production fluids, the flexible pipe body comprising:
an internal pressure sheath;
a helically wound armour layer radially outward of the internal pressure sheath; and
a continuous metallic permeation-barrier layer disposed radially inward of the helically wound armour layer;
wherein the continuous metallic permeation-barrier layer comprises a helically wound tape and a connection portion configured to join laterally adjacent tape wraps of the helically wound tape.

2. The flexible pipe body according to claim 1, wherein the connection portion extends around the circumference of the flexible pipe body.

3. The flexible pipe body according to claim 1, further comprising at least one sacrificial layer radially adjacent the continuous metallic permeation-barrier layer.

4. The flexible pipe body according to claim 3, wherein the flexible pipe body comprises at least two sacrificial layers each radially adjacent the continuous metallic permeation-barrier layer such that the continuous metallic permeation-barrier layer is arranged therebetween.

5. The flexible pipe body according to claim 1, wherein the connection portion comprises a bond between laterally adjacent tape wraps.

6. The flexible pipe body according to claim 5, wherein the bond between adjacent tape wrap of the helically wound tape comprises a welded, brazed, soldered or adhesive bond.

7. The flexible pipe body according to claim 6, wherein the bond follows a pitch of the helically wound tape.

8. The flexible pipe body according to claim 1, wherein the continuous metallic permeation-barrier layer comprises a region of overlap between laterally adjacent tape wraps, such that each tape wrap at least partially covers a laterally adjacent tape wrap.

9. The flexible pipe body according to claim 8, wherein the helically wound tape of the continuous metallic permeation-barrier layer includes a cross-sectional profile comprising at least one bent region or curved region.

10. The flexible pipe body according to claim 9, wherein the cross-sectional profile comprises an undulating region.

11. The flexible pipe body according to claim 1, wherein the helically wound tape has a lay angle relative to the flexible pipe body axis, wherein the lay angle is in the range of from 20 to 80 degrees.

12. A flexible riser comprising the flexible pipe body of claim 1.

13. A method of manufacturing a flexible pipe body, the method comprising:
providing an internal pressure sheath;
providing a metallic permeation-barrier layer, wherein the metallic permeation barrier layer comprises helically wound tape;
joining laterally adjacent tape wraps of the helically wound tape via a connection portion using a bonding process to provide the continuous metallic permeation-barrier layer; and
providing a helically wound armour layer radially outward of the continuous metallic permeation-barrier layer, such that the continuous metallic permeation-barrier is positioned radially inward of the helically wound armour layer.

14. The method according to claim 13, the method further comprising providing at least one sacrificial layer radially adjacent the continuous metallic permeation-barrier layer.

15. The method according to claim 14, further comprising providing at least two sacrificial layers each radially adjacent the continuous metallic permeation-barrier layer such that the metallic permeation-barrier layer is arranged therebetween.

16. The method according to claim 13, wherein the bonding process comprises a welding, brazing, soldering, or adhesive bonding process.

17. The method according to claim 16, wherein the welding process is performed by one or more of Tungsten inert gas welding; metal inert gas welding; laser welding; induction heating; resistance welding; friction welding; or roll bonding.

18. The method according to claim 16, wherein the welding process or the brazing process follows a pitch of the helically wound tape.
